(19) United States
(12) Patent Application Publication
(10) Pub. No.: US 2025/0124334 A1
(43) Pub. Date: Apr. 17, 2025

(54) SYSTEM AND METHOD FOR PROVIDING INFORMATION-DIRECTED PESSIMISM FOR OFFLINE REINFORCEMENT LEARNING

(71) Applicant: JPMorgan Chase Bank, N.A., New York, NY (US)

(72) Inventors: Alec KOPPEL, New York, NY (US); Sujay BHATT, Fresh Meadows, NY (US); Joe EAPPEN, West Lafayette, IN (US); Sumitra GANESH, Short Hills, NJ (US)

(73) Assignee: JPMorgan Chase Bank, N.A., New York, NY (US)

(21) Appl. No.: 18/379,406

(22) Filed: Oct. 12, 2023

(51) Int. Cl. G06N 20/00

(52) U.S. Cl. CPC G06N 20/00

(57) ABSTRACT

A method and system for performing information-directed pessimism in offline learning for reduction of distribution mismatch are disclosed. The method includes determining a first and second distribution for the ML model based on different datasets, and determining a presence of a distribution mismatch between the first distribution and the second distribution. The method further includes calculating a value for an individual state-action pair in a training dataset and comparing the calculated value against a reference data distribution, determining a difference between the calculated value and the reference data distribution and comparing the difference against a reference threshold. When the determined difference is greater than the reference threshold, removing the individual state-action pair from the training dataset as a pessimistic penalty, determining an offset value based on the modified training dataset, and generating a modified ML model based on the determined offset value without retraining the ML model.

### TECHNICAL FIELD

This disclosure generally relates to data regularization. More specifically, the present disclosure generally relates to providing information-directed pessimism for offline reinforcement learning to reduce or eliminate distribution mismatch present in conventional lower confidence-bound pessimism.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

In sequential decision making problems defined by a Markov Decision Process, one must evaluate the currently policy in order to determine how to improve it, which requires access to a generative model/simulator. Without this, and only historical data created by some prior policy (i.e., in offline reinforcement learning), one incurs a distribution mismatch. Prior methods attempt to correct this mismatch with a pessimistic penalty, which is derived from bounds on the tail probability of the mismatch being large, which may result in overly conservative algorithms for reinforcement learning.

### SUMMARY

According to an aspect of the present disclosure, a method for performing information-directed pessimism in offline reinforcement learning for reduction of distribution mismatch is provided. The method includes receiving, by a processor, a machine learning (ML) model; performing, by the processor and using historical data, the ML model estimation for identifying one or more parameters of the ML model; determining, by the processor, a first distribution for the ML model based on training dataset; determining, by the processor, a second distribution for the ML model based on the historical data; determining, by the processor, whether a distribution mismatch between the first distribution and the second distribution is present or not; when the distribution mismatch is determined to be present: calculating a value for an individual state-action pair in the training dataset and comparing the calculated value against a reference data distribution; determining a difference between the calculated value and the reference data distribution and comparing the difference against a reference threshold; when the determined difference is greater than the reference threshold, removing the individual state-action pair from the training dataset as a pessimistic penalty; determining an offset value based on the pessimistic penalty applied to the training dataset; and generating a modified ML model based on the determined offset value without retraining the ML model.

According to another aspect of the present disclosure, the method further includes: updating parameters based on the pessimistic penalty applied to the training dataset.

According to another aspect of the present disclosure, the method further includes: receiving an update to the historical data; determining, by the processor, the second distribution for the ML model based on the updated historical data; and determining whether the distribution mismatch between the first distribution and the second distribution is present or not based on the updated historical data.

According to yet another aspect of the present disclosure, the method further includes: when the distribution mismatch is determined to be absent, continue utilization of the ML model without modification.

According to another aspect of the present disclosure, the calculated value is a Stein kernel.

According to a further aspect of the present disclosure, the method further includes: deploying the modified ML model to a production environment; collecting data in the production environment using the modified ML model; and supplementing the historical data with the data collected in the production environment.

According to yet another aspect of the present disclosure, when the determined difference is less than the reference threshold, retaining the individual state-action pair in the training dataset.

According to a further aspect of the present disclosure, the removing the individual state-action pair from the training dataset as the pessimistic penalty is performed during the offline reinforcement learning.

According to another aspect of the present disclosure, the method further includes: when the distribution mismatch is determined to be below a reference threshold, continue utilization of the ML model without modification.

According to a further aspect of the present disclosure, the historical data is a closed dataset.

According to an aspect of the present disclosure, a system for performing information-directed pessimism in offline reinforcement learning for reduction of distribution mismatch is provided. The system includes a memory, a display and a processor. The system is configured to perform: receiving a machine learning (ML) model; performing, using historical data, the ML model estimation for identifying one or more parameters of the ML model; determining a first distribution for the ML model based on training dataset; determining a second distribution for the ML model based on the historical data; determining whether a distribution mismatch between the first distribution and the second distribution is present or not; when the distribution mismatch is determined to be present: calculating a value for an individual state-action pair in the training dataset and comparing the calculated value against a reference data distribution; determining a difference between the calculated value and the reference data distribution and comparing the difference against a reference threshold; when the determined difference is greater than the reference threshold, removing the individual state-action pair from the training dataset as a pessimistic penalty; determining an offset value based on the pessimistic penalty applied to the training dataset; and generating a modified ML model based on the determined offset value without retraining the ML model.

According to a further aspect of the present disclosure, the system is further configured to perform: updating parameters based on the pessimistic penalty applied to the training dataset.

According to a further aspect of the present disclosure, the system is further configured to perform: receiving an update to the historical data; determining the second distribution for the ML model based on the updated historical data; and determining whether the distribution mismatch between the first distribution and the second distribution is present or not based on the updated historical data.

According to a further aspect of the present disclosure, the system is further configured to perform: when the distribution mismatch is determined to be absent, continue utilization of the ML model without modification.

According to a further aspect of the present disclosure, the system is further configured to perform: deploying the modified ML model to a production environment; collecting data in the production environment using the modified ML model; and supplementing the historical data with the data collected in the production environment.

According to another aspect of the present disclosure, a non-transitory computer readable storage medium that stores a computer program for performing information-directed pessimism in offline reinforcement learning for reduction of distribution mismatch is provided. The computer program, when executed by a processor, causes a system to perform multiple processes including: receiving a machine learning (ML) model; performing, using historical data, the ML model estimation for identifying one or more parameters of the ML model; determining a first distribution for the ML model based on training dataset; determining a second distribution for the ML model based on the historical data; determining whether a distribution mismatch between the first distribution and the second distribution is present or not; when the distribution mismatch is determined to be present: calculating a value for an individual state-action pair in the training dataset and comparing the calculated value against a reference data distribution; determining a difference between the calculated value and the reference data distribution and comparing the difference against a reference threshold; when the determined difference is greater than the reference threshold, removing the individual state-action pair from the training dataset as a pessimistic penalty; determining an offset value based on the pessimistic penalty applied to the training dataset; and generating a modified ML model based on the determined offset value without retraining the ML model.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an information-directed pessimism (IDP) system for offline reinforcement learning in accordance with an exemplary embodiment.

FIG. 2 illustrates an exemplary diagram of a network environment with an IDP system for offline reinforcement learning in accordance with an exemplary embodiment.

FIG. 3 illustrates a system diagram for implementing an IDP system in accordance with an exemplary embodiment.

FIG. 4 illustrates a process flow for performing information-directed pessimism for offline reinforcement learning in accordance with an exemplary embodiment.

FIG. 5 illustrates a method for performing information-directed pessimism for offline reinforcement learning in accordance with an exemplary embodiment.

FIG. 6 illustrates a distribution mismatch between a data distribution of a model/policy based on training dataset and another data distribution of the model/policy based on a different dataset.

FIG. 7 illustrates a lower confidence-bound (LCB) pessimism.

FIGS. 8A-8C illustrate mechanisms for implementing directed pessimism in accordance with an exemplary embodiment.

FIGS. 9A-9B illustrate mechanisms for implementing information-directed pessimism for performing offline Q-learning in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

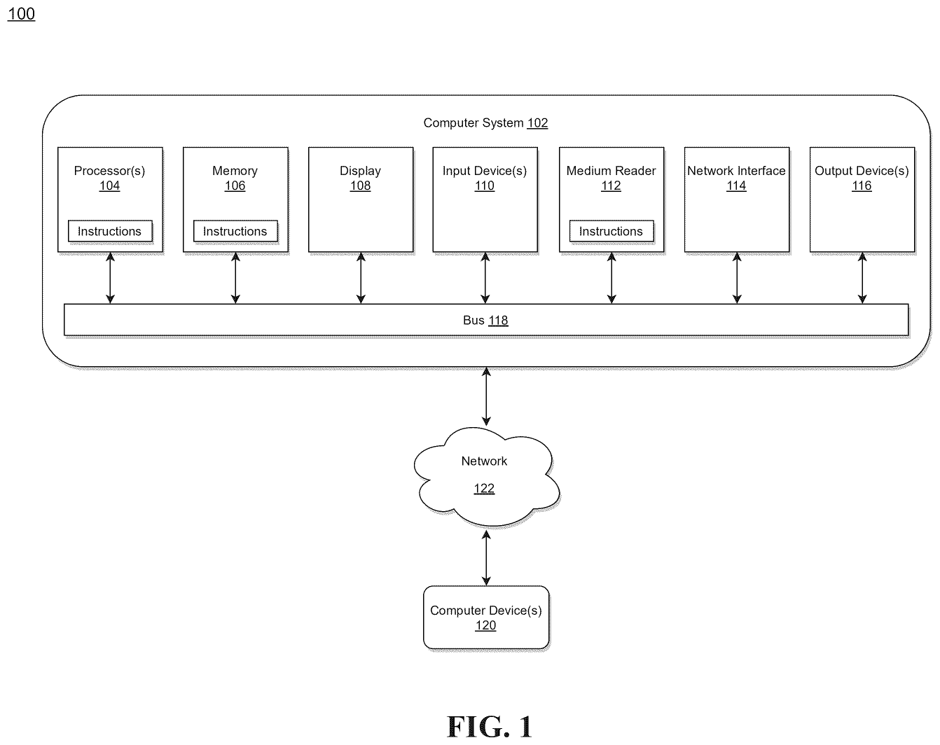

FIG. 1 illustrates a computer system for implementing an information-directed pessimism (IDP) system for offline reinforcement learning in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

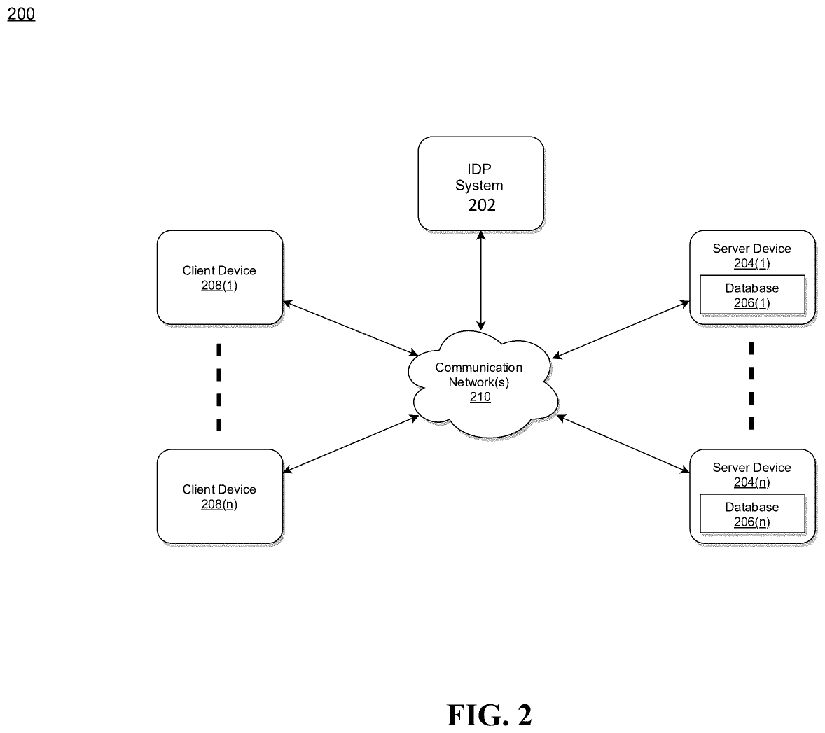

FIG. 2 illustrates an exemplary diagram of a network environment with an IDP system for offline reinforcement learning in accordance with an exemplary embodiment.

An IDP system 202 may be implemented with one or more computer systems similar to the computer system 102 as described with respect to FIG. 1.

The IDP system 202 may store one or more applications that can include executable instructions that, when executed by the IDP system 202, cause the IDP system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the IDP system 202 itself, may be located in virtual server(s) running in a cloud-based computing environment rather than being tied to one or more specific physical network computing devices. Also, the application(s) may be running in one or more virtual machines (VMs) executing on the IDP system 202. Additionally, in one or more embodiments of this technology, virtual machine(s) running on the IDP system 202 may be managed or supervised by a hypervisor.

In the network environment 200 of FIG. 2, the IDP system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the IDP system 202, such as the network interface 114 of the computer system 102 of FIG. 1, operatively couples and communicates between the IDP system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IDP system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The IDP system 202 may be a standalone device or integrated with one or more other devices or apparatuses, such as one or more of the server devices 204(1)-204(n), for example. In one particular example, the IDP system 202 may be hosted by one of the server devices 204(1)-204(n), and other arrangements are also possible. Moreover, one or more of the devices of the IDP system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the IDP system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the IDP system 202 that may efficiently provide a platform for implementing a cloud native IDP system module, but the disclosure is not limited thereto.

The client devices 208(1)-208(n) may run interface applications, such as standard web browsers or standalone client applications, which may provide an interface to communicate with the IDP system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the IDP system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IDP system 202, the server devices 204(1)-204(n), or the client devices 208(1)-208(n), for example, may be configured to operate as virtual instances on the same physical machine. For example, one or more of the IDP system 202, the server devices 204(1)-204(n), or the client devices 208(1)-208(n) may operate on the same physical device rather than as separate devices communicating through communication network(s) 210. Additionally, there may be more or fewer IDP system 202, server devices 204(1)-204(n), or client devices 208(1)-208(n) than illustrated in FIG. 2. According to exemplary embodiments, the IDP system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

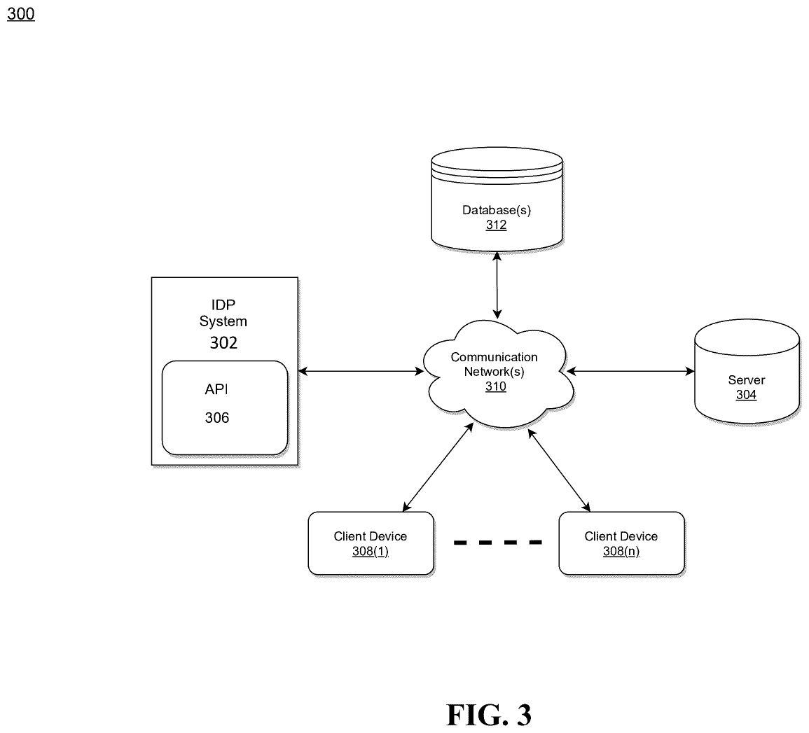

FIG. 3 illustrates a system diagram for implementing an IDP system for offline reinforcement learning in accordance with an exemplary embodiment.

As illustrated in FIG. 3, the system 300 may include a IDP system 302 within which a group of API modules 306 is embedded, a server 304, a database(s) 312, a plurality of client devices 308(1) . . . 308(n), and a communication network 310.

According to exemplary embodiments, the IDP system 302 including the API modules 306 may be connected to the server 304, and the database(s) 312 via the communication network 310. Although there is only one database that has been illustrated, the disclosure is not limited thereto. Any number of databases may be utilized. The IDP system 302 may also be connected to the plurality of client devices 308(1) . . . 308(n) via the communication network 310, but the disclosure is not limited thereto.

According to exemplary embodiment, the IDP system 302 is described and shown in FIG. 3 as including the API modules 306, although it may include other rules, policies, modules, databases, or applications, for example. According to exemplary embodiments, the database(s) 312 may be embedded within the IDP system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable IDP system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the IDP system 302. In this regard, the plurality of client devices 308(1) . . . 308(n) may be “clients” of the IDP system 302 and are described herein as such. Nevertheless, it is to be known and understood that the plurality of client devices 308(1) . . . 308(n) need not necessarily be “clients” of the IDP system 302, or any entity described in association therewith herein. Any additional or alternative relationship may exist between either or both of the plurality of client devices 308(1) . . . 308(n) and the IDP system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the IDP system 302 via broadband or cellular communication. Of course, these embodiments are merely exemplary and are not limiting or exhaustive.

The client devices 308(1) . . . 308(n) may be the same or similar to any one of the client devices 208(1)-208(n) as described with respect to FIG. 2, including any features or combination of features described with respect thereto. The IDP system 302 may be the same or similar to the IDP system 202 as described with respect to FIG. 2, including any features or combination of features described with respect thereto.

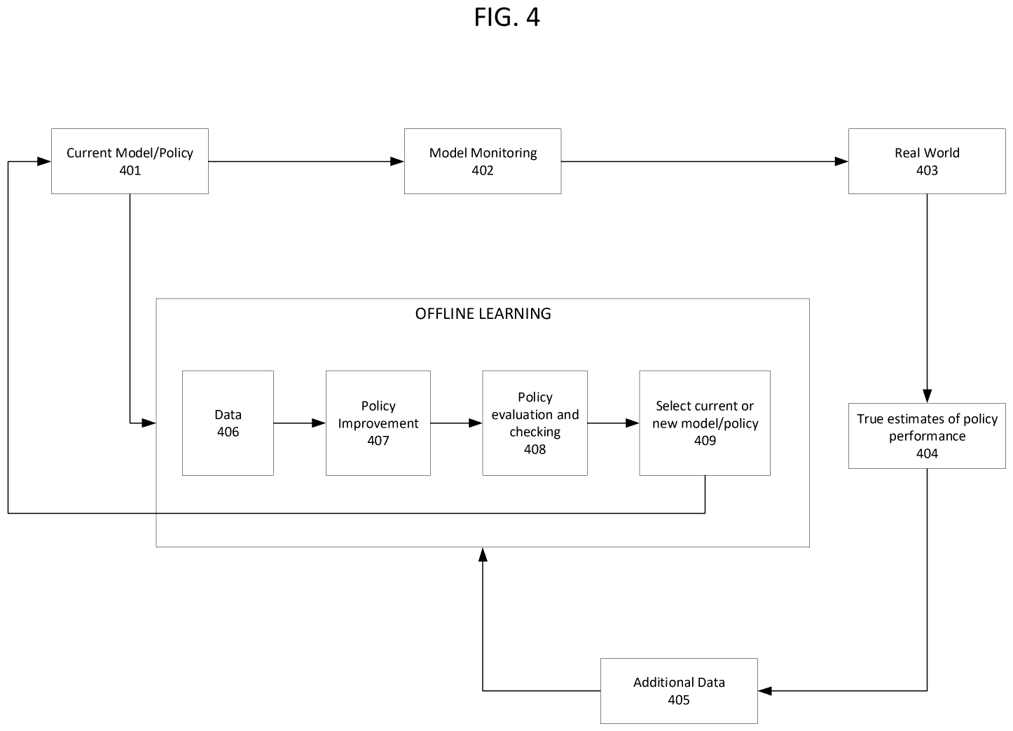

FIG. 4 illustrates a process flow for performing information directed pessimism for offline reinforcement learning in accordance with an exemplary embodiment.

According to exemplary aspects, a data-driven way to correct for distributional mismatch is provided. More specifically, the data-driven way to correct for distributional mismatch found in offline learning is provided by evaluating the degree to which offline data has overlap with the current element in a trajectory during training. According to aspects, the evaluating may be performed based on statistical machinery, such as kernelized Stein discrepancy. The above described evaluation may approximate mutual information between empirical distribution associated with offline data and the one experienced during policy optimization.

According to further aspects, the above described data-driven way to correct for distributional mismatch results in a data-driven penalty is provided, in contrast to conventional probability based pessimistic penalty, which may not effectively remove the distribution mismatch resulting from offline learning. More specifically, the respective data-driven pessimism for offline learning is based on actual data and not mere probability, and thus better respects the information contained in offline data, and may not overly conservative in the face of uncertainty. In other words, a more accurate prediction may be performed even in the face of uncertainty. Additional advantage may include providing more sample efficient policy optimization from offline data.

In operation 401, a current machine learning (ML) or artificial intelligence (AI) model or policy may be received at the IDP system. According to exemplary aspects, reinforcement learning may be performed to improve accuracy or update the ML model.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

In operation 402, the provided model or policy is then monitored for its performance. According to exemplary aspects, performance of the provided model or policy may be monitored continuously or intermittently according to a set schedule. However, aspects of the present disclosure are not limited thereto, such that the performance of the provided model or policy may be monitored in response to an event.

In operation 403, real-world data may be collected using the current model/policy. According to exemplary aspects, real-world data may be collected in real-time and in an online state under the current model/policy.

In operation 404, true estimates or parameters of the current model/policy performance are collected. According to exemplary aspects, true estimates or parameters may refer to internal variables of the current model/policy. In an example, the true estimates or parameters may be learned or estimated from the data processed via the current model/policy.

In operation 405, additional real-world data collected may be transmitted to the database storing the historical data 406. More specifically, additional real-data may be collected and stored to supplement the historical data 406 already stored in the database. According to exemplary aspects, additional real-world data may be supplemented continuously with respect to time, such that more representative information may be provided over time. In an example, the additional data may include, without limitation, state, action and the like.

According to exemplary aspects, offline reinforcement learning may include operations 406, operation 407, operation 408 and operation 409.

More specifically, according to exemplary aspects, the offline reinforcement learning approach may involve learning from prior collected, and subsequent deployment in production. The offline reinforcement learning approach may train a policy on existing datasets, which may comprise a sufficient sample size. Further, additional benefits may include that it is safe for production, and requires no in-situ training or face simulation-to-real world gaps. According to further aspects, the offline reinforcement learning approach may require data coverage, providing similarity in prior experience, in-production data, and statistical diversity. Moreover, the offline reinforcement learning approach may impose realizability (e.g., one has chosen good features/function class). However, typical offline reinforcement learning may be unable to eliminate distribution mismatch (e.g., how similar prior collected data is to production data).

According to further aspects, the offline reinforcement learning approach may take few different forms, including those in the pessimism (i.e., subtract uncertainty estimate group, and those in the importance weighting and off policy evaluation (i.e., estimators suffer from exponential variance) group. The offline reinforcement learning approach forms in the pessimism group includes, without limitation, policy (e.g., trust region/proximal), rewards and transition model reweighting, and value regularization. Further, the offline reinforcement learning approach forms in the importance weighting and off policy evaluation group includes, without limitation, density ration reweighting, state marginal matching and bootstrapping.

According to exemplary aspects, pessimism generally attempts to deal with spurious correlations, which may be represented by the following equation:

( [symbol] − [symbol] )Qₜ

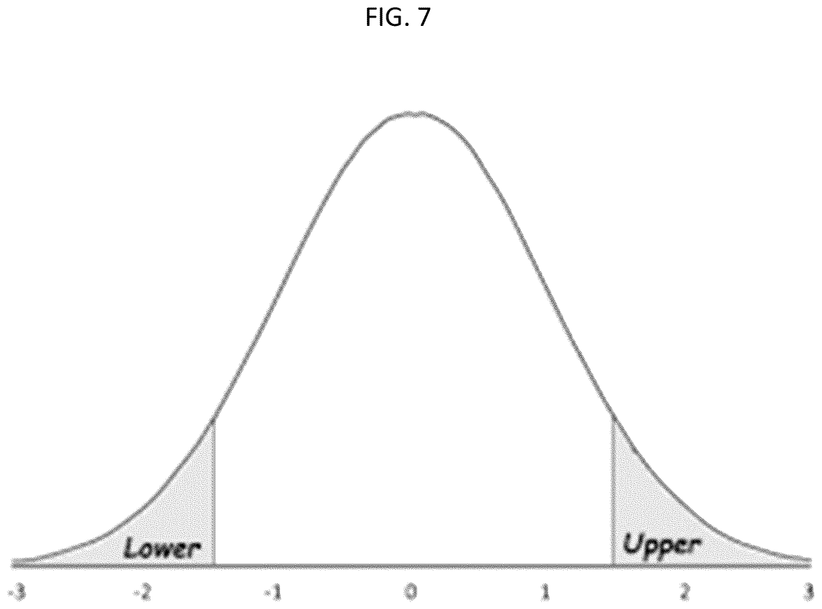

Further, the above noted spurious correlation is also exemplarily illustrated in FIG. 7. Generally, pessimism attempts to determine how different is estimated Q-function from data batch [symbol] compared to the true transition model [symbol] . As exemplarily illustrated in FIG. 7, pessimism or spurious correlation may often be crudely approximated by bound on tail probability. Such practice may provide decreasing function of number of visitations to a state-action pair. Further, such practice may be overly conservative, and may be only tight for unimodal/sub-exponential distributions. Also, general pessimism may be unable to evaluate data quality, as it is not directed towards the distribution mismatch. In addition to the above, methods that seek direct evaluation of pessimism term may require density estimation, which may exhibit tractability problems.

In view of the above noted limitations, general pessimism may not be utilized to address the distribution mismatch in a model or policy. Instead, a pessimistic penalization directed to annihilate mismatch in Q-function/policy gradient may be provided. The proposed approach may also be computable in closed form. Further, the pessimistic penalization may configure the penalty to be dependent on a current state-action pair. The pessimistic penalization may include a value approach and a policy gradient (PG) context approach.

According to exemplary aspects, the value approach to the pessimistic penalization, a mixture model may be hypothesized. In other words, the spurious correlation may roughly equal to an integral probability metric. More specifically, the value approach may be computable in a closed form under some special conditions, such as when Q function is a mixture model as provided below:

$$( ℙ - \hat{ℙ} ) {Q}_{t} = d ( ℙ {Q}_{t} , \hat{ℙ} {Q}_{t} ) \approx KSD ( \hat{ℙ} {Q}_{t} )$$

$$\to if ℙ {Q}_{t} belongs to “ Stein Class ” ( smoothness condition )$$

$$\to Q belongs to RKHS ( mixture family )$$

In an example, KSD may refer to score-based kernelized Stein discrepancy (KSD), and RKHS may refer to a reproducing kernel Hilbert space.

In operation 406, historical data (e.g., state, action) collected under the current model/policy stored in the database may then be applied to the current model/policy in an offline setting for performing offline reinforcement learning. According to exemplary aspects, the offline reinforcement learning leverages the historical data collected under the current model/policy, which is static during the offline reinforcement learning, without interaction the production environment. In other words, the offline reinforcement learning is performed with a static set of data.

More specifically, there are two types of reinforcement learning that may be available, online reinforcement learning and offline reinforcement learning. However, the online or on-policy reinforcement learning may be inoperable for production system at least since (i) it takes risky real-time decisions to learn good policy, (ii) in practice, a simulator may be built, but it incurs a gap between the simulation and the real-world, and (iii) sample size is typically insufficient. In view of such short comings, the offline reinforcement learning approach is proposed for implementation.

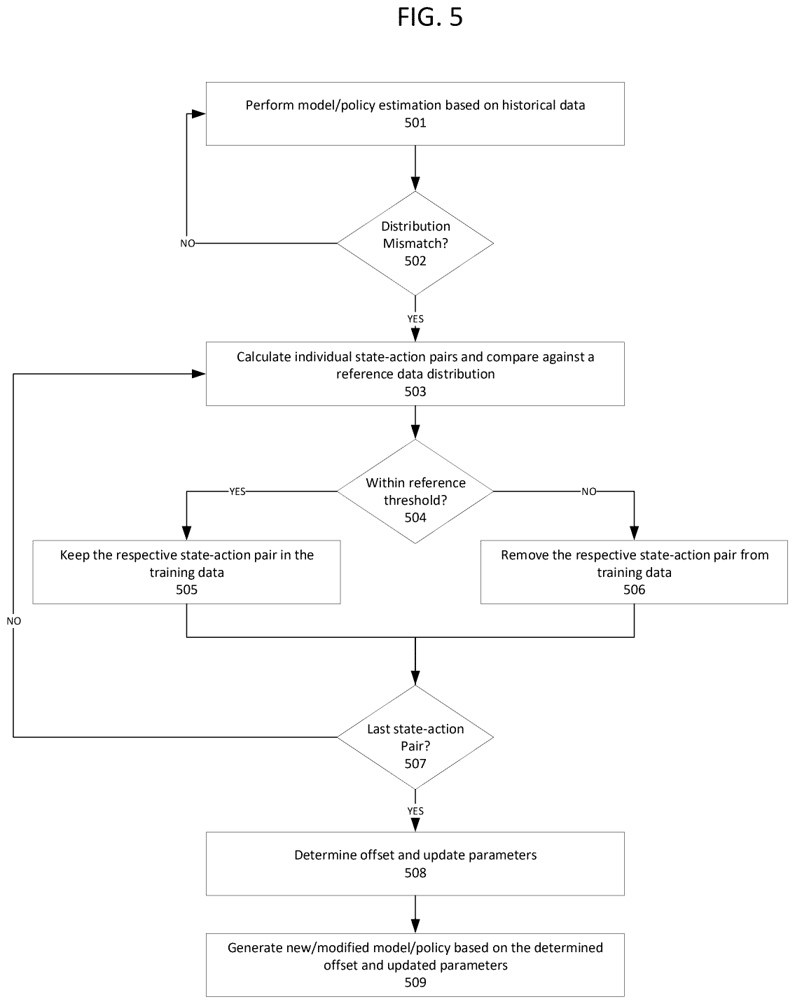

In operation 407, one or more policy improvements may be performed. According to exemplary aspects, the one or more policy improvements include, without limitation, determining baseline performance of the current model or policy, performing of model/policy optimization via offline reinforcement learning and the like. More detailed operations performed during the policy improvements may be described with respect to FIG. 5 as discussed below.

In operation 501, current model/policy estimation is performed using the historical data.

In operation 502, a determination of whether a distribution mismatch has occurred in response to operation 501 is determined. In an example, a distribution mismatch may occur when the training dataset and the test dataset are not drawn from the same distribution.

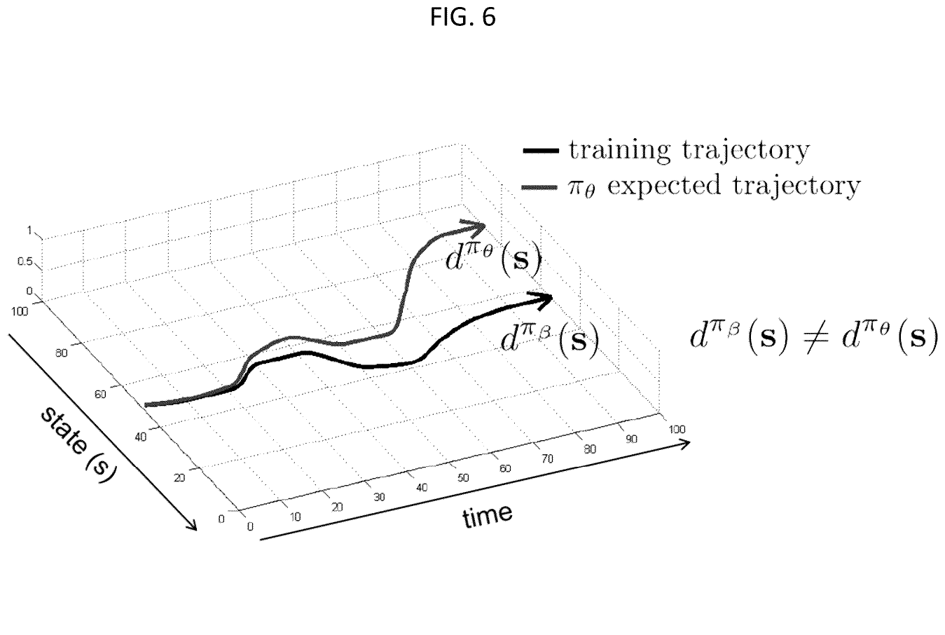

When a distribution mismatch is present, there may be gap between a distribution of the training dataset and the other dataset as illustrated in FIG. 6. More specifically, a particular model/policy may provide one distribution with training data, but may provide a differing distribution when differing dataset is utilized. In such a case, a data distribution based on training data (d^{π}^{_{θ}}(s)) may not match well with a data distribution based on differing data (d^{π}^{_{β}}(s)), such as historical data. When the distribution mismatch is determined to be present, and such distribution match is above a reference threshold, then the current model or policy may be flagged for performing off-line reinforcement.

When distribution mismatch is determined not to be present in operation 502, no further analysis may be performed, and the method may proceed back to operation 501 where the model/policy may perform another estimation when data stored in the database is updated. On the other hand, when distribution mismatch is determined to be present in operation 502, the method proceeds to operation 503.

In operation 503, Stein kernel values for individual state-action pairs are calculated and compared against a reference data distribution for identifying pessimism or pessimistic penalty to be applied to the current model/policy. According to exemplary aspects, operation 503 may be performed for each pair in a test dataset provided in the historical data. Information-directed pessimism is distinguished from a conventional pessimistic penalty (e.g., lower confidence-bound pessimism) that relies on probability of distribution without specific regard to individual data values.

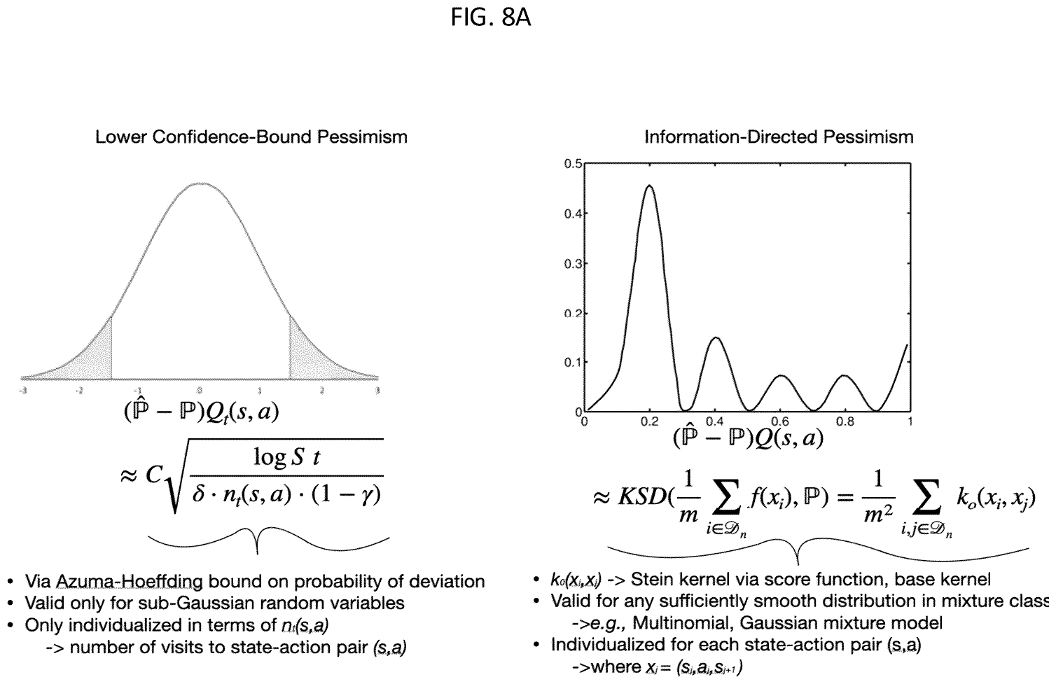

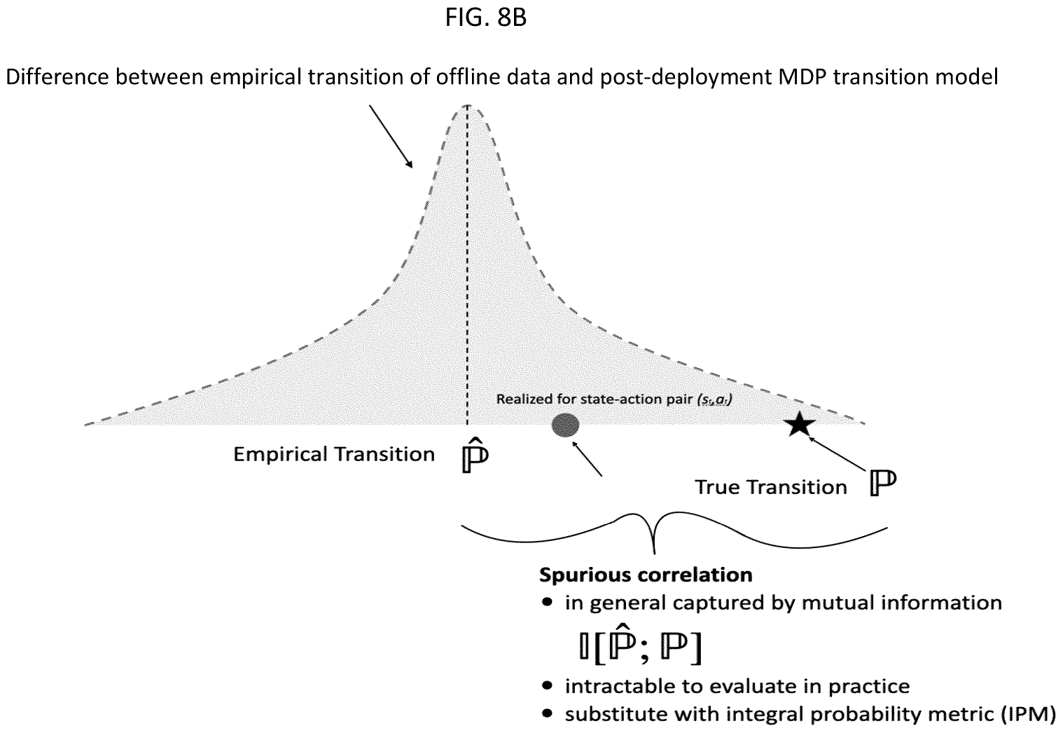

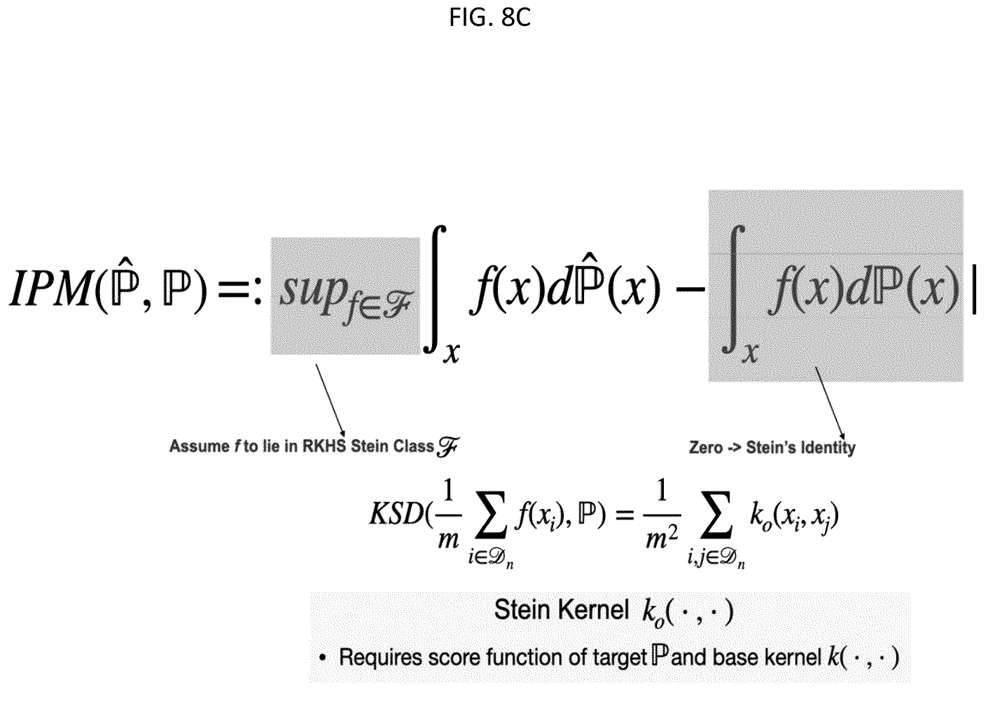

As exemplarily illustrated in FIG. 8A, lower confidence-bound pessimism may capture values at the lower and upper end of the data distribution and remove them from consideration. Such removal is performed based on probability alone, without regard to individual data in the data. Accordingly, such removal may lead to a skewed and inaccurate distribution that may not effectively remove the distribution mismatch and accurately correspond to real-world situations.

In the lower confidence-bound pessimism, a data distribution may be calculated via Azuma-Hoeffding bound on probability of deviation. The Azuma-Hoeffding may provide concentration results for values that may have bounded differences. However, the lower confidence-bound pessimism approach may be valid only for sub-Gaussian random variables, and may be individualized only in terms of nₜ(s, a), which may represent a number (n) of visits to a state-action pair (s, a).

On the other hand, in the information-directed pessimism approach, the data distribution may be calculated using a Stein kernel via a score function, base kernel. Further, the information-directed pessimism may be valid for any sufficiently smooth distribution in mixture class (e.g., multinomial, Gaussian mixture model and the like). Moreover, the information-directed pessimism approach may be individualized for each state-action pair (s,a), where xⱼ=(sⱼ, aⱼ, sⱼ₊₁).

As exemplarily illustrated in FIG. 8B, a difference between empirical transition ( [symbol] ) of offline data and post-deployment Markov Decision Process (MDP) ( [symbol] ) is captured by spurious correlation. According to exemplary aspects, spurious correlation may be captured by mutual information ( [symbol] [ [symbol] ; [symbol] ]). In an example, spurious correlation or relationship may refer to a mathematical relationship in which two or more events or variables are associated but not causally related. However, spurious correlation may be intractable to evaluate in practice. Accordingly, spurious correlation may be substituted with integral probability metric (IPM) as exemplarily illustrated in FIG. 8C. As noted in FIG. 8C, Stein Kernel k₀(⋅, ⋅) requires a score function of target P and base kernel k (⋅, ⋅).

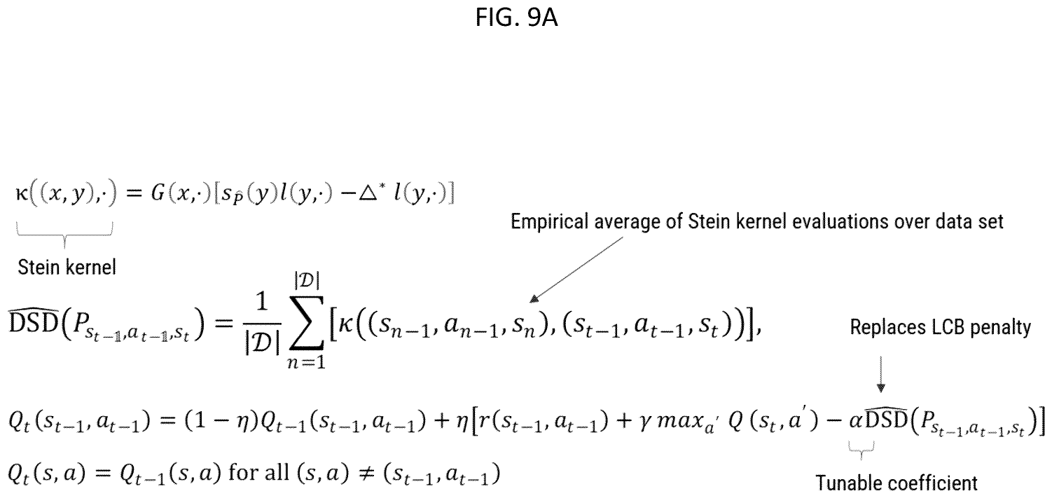

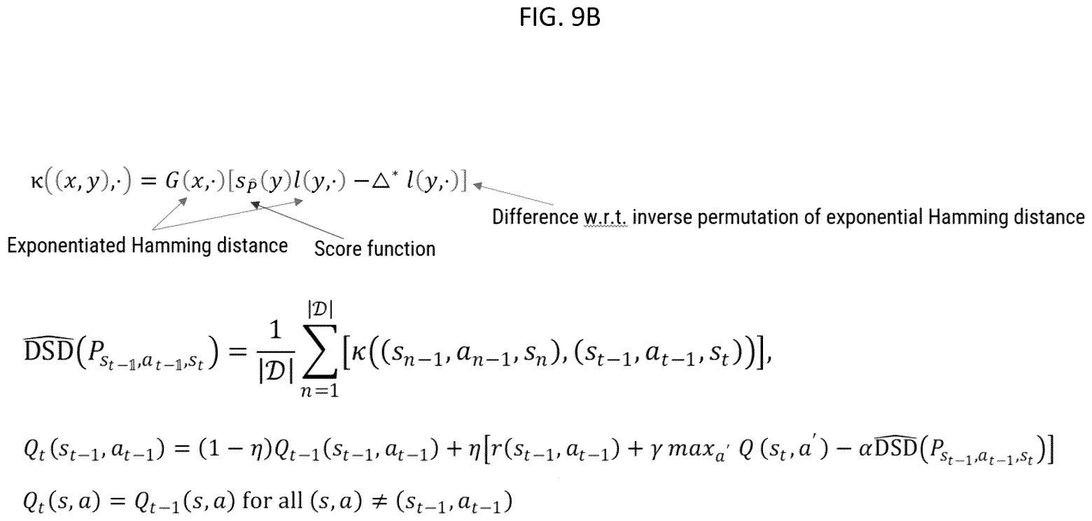

According to exemplary aspects, a Stein kernel value (k((x,y);) may be calculated using an equation illustrated in FIG. 9A. More specifically, the Stein kernel may be based on an exponential Hamming distance, a score function, and a difference with respect to inverse permutation of exponential Hamming distance as provided in FIG. 9B.

In operation 504, a difference between a Stein kernel value of the respective state-action pair and the reference data distribution is calculated and compared against a reference threshold to determine whether the difference is within the reference threshold or not. When an individual state-action pair is determined to be within the reference threshold, the respective state-action pair is to remain in the training data in operation 505. On the other hand, when the individual state-action pair is determined to be outside of the reference threshold, the respective state-action pair is removed from the training data as information-directed pessimistic penalty ( [symbol] ) in operation 506. According to exemplary aspects, calculation of the pessimistic penalty may be calculated using an equation for [symbol] as illustrated in FIG. 9A.

Subsequent to both operation 505 and operation 506, a check is performed to determine whether the respective state-action pair is the last pair in the test dataset or not. If the state-action pair is determined not to be the last pair in the test dataset, the method returns to operation 503 for another state-action pair in the test dataset. On the other hand, if the state-action pair is determined to be the last pair in the test dataset, the method proceeds to operation 508.

In operation 508, an offset value may be determined, and parameters may be updated based on the modified training data. In operation 509, a new or modified model/policy may be generated based on the determined offset value and updated parameters. In an example, an offset may refer to a bias value that may be applied to an existing model without requiring generation of a new model. Accordingly, a new/modified model/policy may be provided for utilization without requiring new training of the new/modified model/policy, which may result in computing efficiencies (e.g., CPU and memory utilization).

In operation 408, evaluation is performed on the current model or policy, and perform validations on the current model or policy. Based on the evaluation and validation in operation 408, either a new policy/model 409 or the current model/policy may be selected for continued application. For example, if the results of operation 407 indicates that the current model/policy does not provide a distribution mismatch, the current model/policy may be selected for continued utilization. On the other hand, if the results of operation 407 indicates that the current model/policy provides the distribution mismatch, information-directed pessimistic penalty may be applied, and a new/modified model/policy may be selected for implementation.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing information-directed pessimism in offline reinforcement learning for reduction of distribution mismatch, the method comprising:
receiving, by a processor, a machine learning (ML) model;
performing, by the processor and using historical data, the ML model estimation for identifying one or more parameters of the ML model;
determining, by the processor, a first distribution for the ML model based on training dataset;
determining, by the processor, a second distribution for the ML model based on the historical data;
determining, by the processor, whether a distribution mismatch between the first distribution and the second distribution is present or not;
when the distribution mismatch is determined to be present:
calculating a value for an individual state-action pair in the training dataset and comparing the calculated value against a reference data distribution;
determining a difference between the calculated value and the reference data distribution and comparing the difference against a reference threshold;
when the determined difference is greater than the reference threshold, removing the individual state-action pair from the training dataset as a pessimistic penalty;
determining an offset value based on the pessimistic penalty applied to the training dataset; and
generating a modified ML model based on the determined offset value without retraining the ML model.

2. The method according to claim 1, further comprising:
updating parameters based on the pessimistic penalty applied to the training dataset.

3. The method according to claim 1, further comprising:
receiving an update to the historical data;
determining, by the processor, the second distribution for the ML model based on the updated historical data; and
determining whether the distribution mismatch between the first distribution and the second distribution is present or not based on the updated historical data.

4. The method according to claim 1, further comprising:
when the distribution mismatch is determined to be absent, continue utilization of the ML model without modification.

5. The method according to claim 1, wherein the calculated value is a Stein kernel.

6. The method according to claim 1, further comprising:
deploying the modified ML model to a production environment;
collecting data in the production environment using the modified ML model; and
supplementing the historical data with the data collected in the production environment.

7. The method according to claim 1, wherein, when the determined difference is less than the reference threshold, retaining the individual state-action pair in the training dataset.

8. The method according to claim 1, wherein the removing the individual state-action pair from the training dataset as the pessimistic penalty is performed during the offline reinforcement learning.

9. The method according to claim 1, further comprising:
when the distribution mismatch is determined to be below a reference threshold, continue utilization of the ML model without modification.

10. The method according to claim 1, wherein the historical data is a closed dataset.

11. A system for performing information-directed pessimism in offline reinforcement learning for reduction of distribution mismatch, the system comprising:
a memory; and
a processor,
wherein the system is configured to perform:
receiving a machine learning (ML) model;
performing, using historical data, the ML model estimation for identifying one or more parameters of the ML model;
determining a first distribution for the ML model based on training dataset;
determining a second distribution for the ML model based on the historical data;
determining whether a distribution mismatch between the first distribution and the second distribution is present or not;
when the distribution mismatch is determined to be present:
calculating a value for an individual state-action pair in the training dataset and comparing the calculated value against a reference data distribution;
determining a difference between the calculated value and the reference data distribution and comparing the difference against a reference threshold;
when the determined difference is greater than the reference threshold, removing the individual state-action pair from the training dataset as a pessimistic penalty;
determining an offset value based on the pessimistic penalty applied to the training dataset; and
generating a modified ML model based on the determined offset value without retraining the ML model.

12. The system according to claim 11, wherein the system is further configured to perform:
updating parameters based on the pessimistic penalty applied to the training dataset.

13. The system according to claim 11, wherein the system is further configured to perform:
receiving an update to the historical data;
determining the second distribution for the ML model based on the updated historical data; and
determining whether the distribution mismatch between the first distribution and the second distribution is present or not based on the updated historical data.

14. The system according to claim 11, wherein the system is further configured to perform:
when the distribution mismatch is determined to be absent, continue utilization of the ML model without modification.

15. The system according to claim 11, wherein the calculated value is a Stein kernel.

16. The system according to claim 11, wherein the system is further configured to perform:
deploying the modified ML model to a production environment;
collecting data in the production environment using the modified ML model; and
supplementing the historical data with the data collected in the production environment.

17. The system according to claim 11, wherein, when the determined difference is less than the reference threshold, retaining the individual state-action pair in the training dataset.

18. The system according to claim 11, wherein the removing the individual state-action pair from the training dataset as the pessimistic penalty is performed during the offline reinforcement learning.

19. The system according to claim 11, wherein the system is further configured to perform:
when the distribution mismatch is determined to be below a reference threshold, continue utilization of the ML model without modification.

20. A non-transitory computer readable storage medium that stores a computer program for performing information-directed pessimism in offline reinforcement learning for reduction of distribution mismatch, the computer program, when executed by a processor, causing a system to perform a plurality of processes comprising:
receiving a machine learning (ML) model;
performing, using historical data, the ML model estimation for identifying one or more parameters of the ML model;
determining a first distribution for the ML model based on training dataset;
determining a second distribution for the ML model based on the historical data;
determining whether a distribution mismatch between the first distribution and the second distribution is present or not;
when the distribution mismatch is determined to be present:
calculating a value for an individual state-action pair in the training dataset and comparing the calculated value against a reference data distribution;
determining a difference between the calculated value and the reference data distribution and comparing the difference against a reference threshold;
when the determined difference is greater than the reference threshold, removing the individual state-action pair from the training dataset as a pessimistic penalty;
determining an offset value based on the pessimistic penalty applied to the training dataset; and
generating a modified ML model based on the determined offset value without retraining the ML model.
